(19) United States
(12) Patent Application Publication
(10) Pub. No.: US 2015/0189051 A1
(43) Pub. Date: Jul. 2, 2015

(54) ELECTRONIC APPARATUS

(71) Applicant: KYOCERA Corporation, Kyoto-shi (JP)

(72) Inventors: Motohiro Umehara, Yasu-shi (JP); Takashi Uto, Higashiomi-shi (JP); Yoshinori Kubo, Omihachiman (JP); Satoru Tsubokura, Higashiomi-shi (JP)

(21) Appl. No.: 14/460,971

(22) Filed: Aug. 15, 2014

(30) Foreign Application Priority Data
Dec. 26, 2013 (JP) 2013-269004
Dec. 26, 2013 (JP) 2013-269005
Dec. 26, 2013 (JP) 2013-269160

(51) Int. Cl. H04M 1/02

(52) U.S. Cl. CPC H04M 1/0266; H04M 1/0202

(57) ABSTRACT

An electronic apparatus is disclosed. The electronic apparatus includes an exterior body, a wireless communication unit, and a display device. The exterior body includes a wireless communication unit, a display device and an exterior body. The exterior body includes a light-transmissive cover plate and a case member. The light-transmissive cover plate includes: first and second surfaces opposite to each other; and a single crystal body containing alumina (Al₂O₃) as a main component. The case member is disposed at an opposite side to the light-transmissive cover plate with respect to the display device and includes a single crystal body containing alumina (Al₂O₃) as a main component. The wireless communication unit and the display device are in the exterior body. The display device includes a display surface that faces the first surface.

### CROSS-REFERENCE TO RELATED APPLICATION

The present application claims priority under 35 U.S.C. §119 to Japanese Patent Application No. 2013-269004, filed on Dec. 26, 2013, entitled “ELECTRONIC APPARATUS”; to Japanese Patent Application No. 2013-269005, filed on Dec. 26, 2013, entitled “ELECTRONIC APPARATUS”; and to Japanese Patent Application No. 2013-269160, filed on Dec. 26, 2013, entitled “ELECTRONIC APPARATUS”, all incorporated by reference in their entirety, herein.

### FIELD

Embodiments of an invention generally relate to electronic apparatuses with a display, and more particularly relates to an electronic device having a cover plate, which includes a single crystal member, on the display.

### BACKGROUND

A conventional electronic apparatus may include a wireless communication unit and a display therein. In particular, a portable electronic apparatus such as a so-called smartphone or a tablet may include a relatively large display and an input device such as a touch panel. A smartphone or a tablet may include an exterior body that includes, for example, so-called strengthened glass composed of aluminosilicate glass, a resin material, or the like.

### SUMMARY

An electronic apparatus is presented. The electronic apparatus includes a plurality of functional units that include at least a wireless communication unit; an image display device that includes an image display surface; and an exterior body that houses the plurality of functional units, in which the exterior body includes a light-transmissive cover plate that includes a first surface facing the image display surface and a second surface positioned on the opposite side to the first surface and a case member that is provided on the opposite side to the light-transmissive cover plate with respect to the image display device, the light-transmissive cover plate is made of a single crystal body containing alumina (Al₂O₃) as a main component, and the case member includes a single crystal body containing alumina (Al₂O₃) as a main component.

### BRIEF DESCRIPTION OF THE DRAWINGS

FIG. 1 is a perspective view illustrating an electronic apparatus.

FIG. 2 is an exploded perspective view of the electronic apparatus illustrated in FIG. 1.

FIG. 3 is a front view of electronic apparatus

FIG. 4 is a rear view of electronic apparatus.

FIG. 5 is a block diagram illustrating an electrical configuration of the electronic apparatus.

FIG. 6 is a perspective view of an electronic apparatus.

FIG. 7A is a plan view of a mounting body.

FIG. 7B is a cross-sectional view of the mounting body illustrated in FIG. 7A.

FIG. 8A is a plan view of a mounting body.

FIG. 8B is a cross-sectional view of the mounting body illustrated in FIG. 8A.

FIG. 9 is a plan view of a piezoelectric vibrating element.

FIG. 10 is a side view of the piezoelectric vibrating element.

FIG. 11 illustrates the piezoelectric vibrating element that is being bent.

FIG. 12 is illustrates the piezoelectric vibrating element that is being bent.

FIG. 13 is a plan view of a light-transmissive cover plate.

FIG. 14 illustrates paths of an air conduction sound and a conduction sound.

### DETAILED DESCRIPTION

The following description is presented to enable a person of ordinary skill in the art to make and use the embodiments of the disclosure. The following detailed description is an example and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one practical non-limiting application, namely, an electronic apparatus such as a mobile phone. Embodiments of the disclosure, however, are not limited to such mobile phone, and the techniques described herein may be utilized in other applications. For example, embodiments may be applicable to e-readers, digital cameras, electronic game machines, digital music players, personal digital assistants (PDA), tablets, personal handy phone system (PHS), laptop computers, TV's, Global Positioning Systems (GPS's) or navigation systems, health equipment, and other communication device. As would be apparent to one of ordinary skill in the art after reading this description, these are merely examples and the embodiments of the disclosure are not limited to operating in accordance with these examples. Other embodiments may be utilized and structural changes may be made without departing from the scope of the example embodiments of the present disclosure.

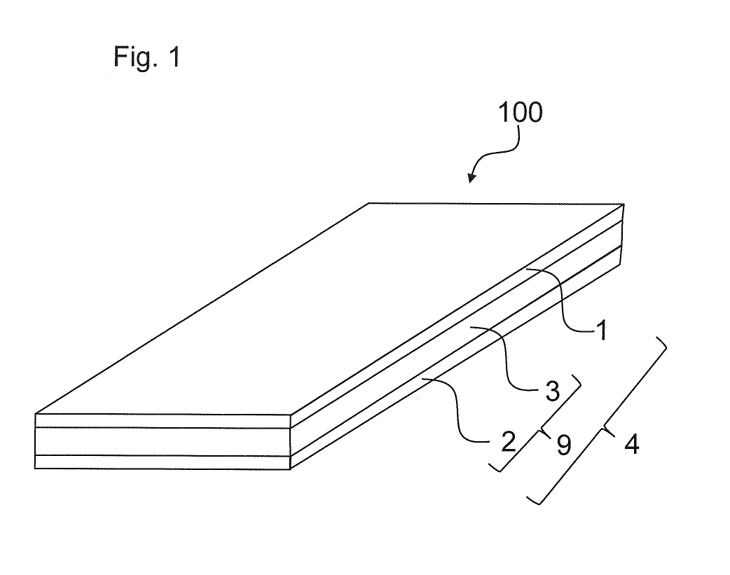

FIGS. 1 to 5 illustrate an electronic apparatus 100. FIG. 1 is a perspective view illustrating an electronic apparatus 100.

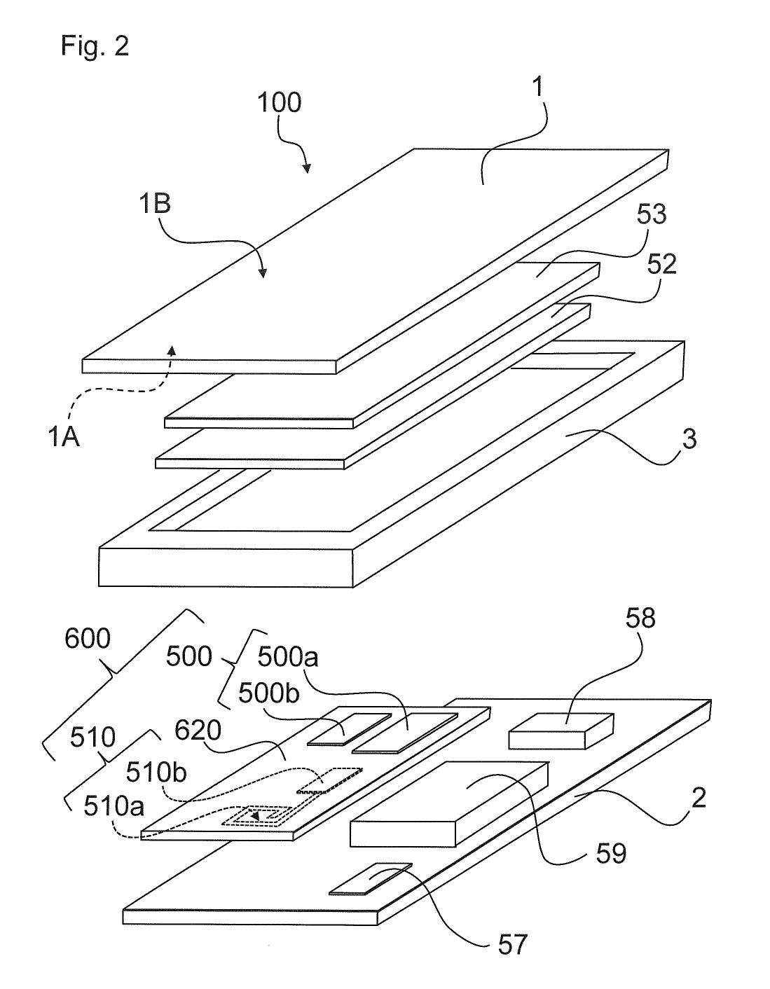

FIG. 2 is an exploded perspective view of the electronic apparatus 100 illustrated in FIG. 1.

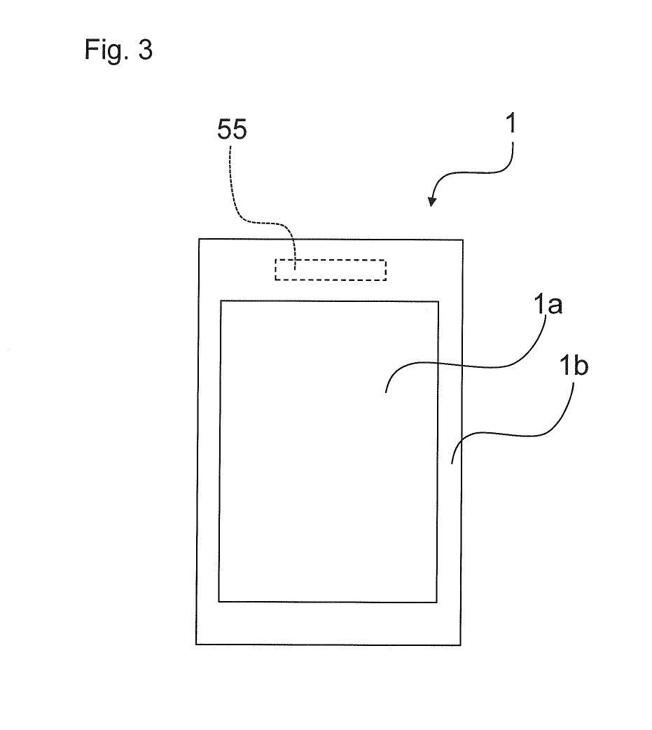

FIG. 3 is a front view of the electronic apparatus 100.

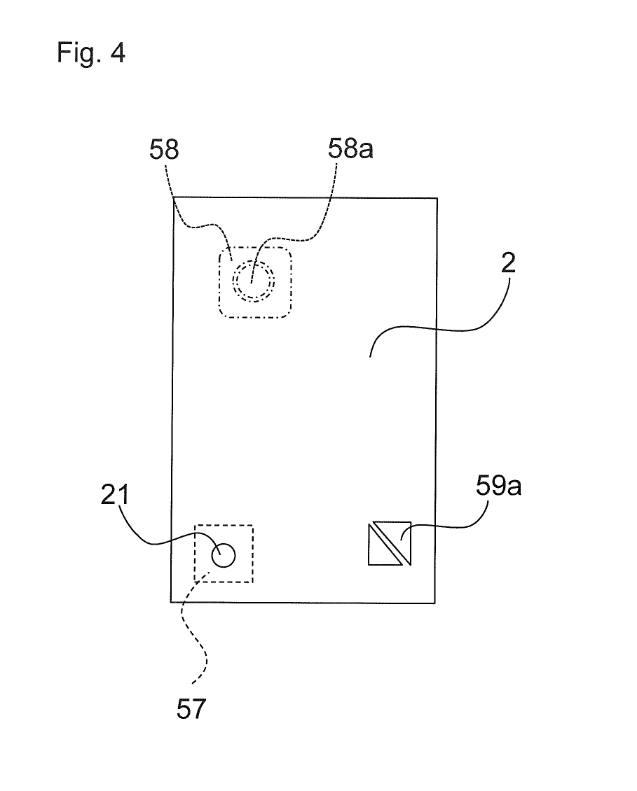

FIG. 4 is a rear view of the electronic apparatus 100.

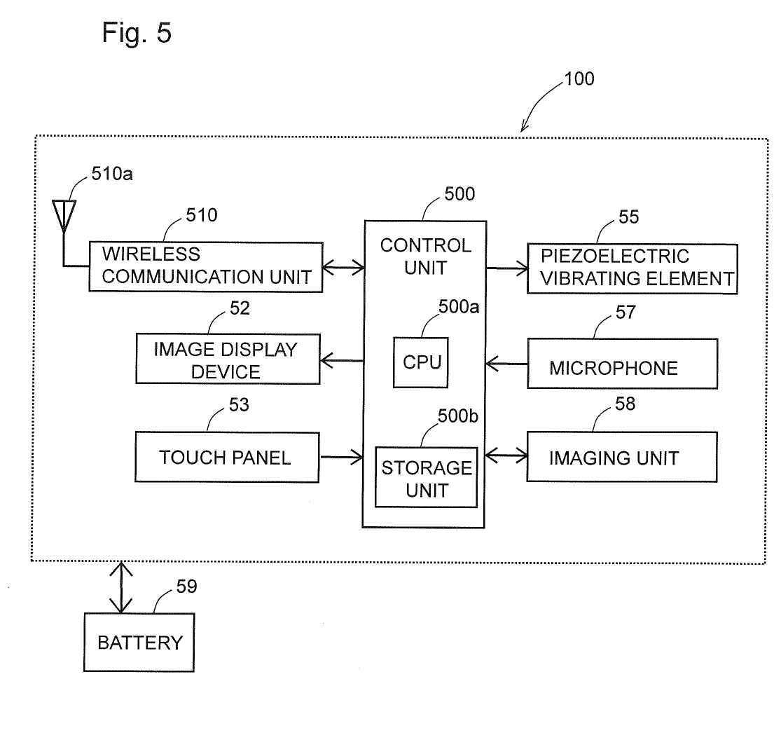

FIG. 5 is a block diagram illustrating an electrical configuration of the electronic apparatus 100.

As illustrated in FIG. 2, the electronic apparatus 100 may include a control unit 500, a wireless communication unit 510, an image display device 52, a touch panel 53, a microphone 57, an imaging unit 58, and a battery 59 as functional units. In addition, functional units are not limited to the illustrated respective units and plural kinds of devices may be incorporated therein.

The electronic apparatus 100 may include a plurality of functional units that include at least a wireless communication unit 510. The electronic apparatus 100 may also include an exterior body 4 that houses the plurality of functional units. The exterior body 4 may include a light-transmissive cover plate 1, which has a first surface 1A facing an image display surface of the image display device 52 and a second surface 1B positioned on the opposite side to the first surface 1A. The exterior body 4 may also include a case member 9 provided on the opposite side to the light-transmissive cover plate 1 with respect to the image display device 52. The light-transmissive cover plate 1 may be made of a single crystal containing alumina (Al₂O₃) as a main component and the case member 9 includes a single crystal containing alumina (Al₂O₃) as a main component. The wireless communication unit 510 receives and transmits electromagnetic waves through a portion made of a single crystal containing alumina (Al₂O₃) as a main component. In the present disclosure, the “main component” of the single crystal body refers an amount of at least 50% by mass and preferably 70% by mass with respect to the total mass of the single crystal. A single crystal containing alumina (Al₂O₃) as a main component is also known as sapphire.

In one embodiment, a case member includes at least two sapphire members that are bonded to each other. As illustrated in FIG. 1, the case member 9 includes a back plate 2 and a frame body 3. The back plate 2 and the frame body 3 may be composed of a single crystal that contains alumina (Al₂O₃) as a main component. The light-transmissive cover plate 1 and the back plate 2 have a substantially rectangular shape in a plan view. The light-transmissive cover plate 1, the back plate 2, and the frame body 3 are combined to form an exterior body 4.

Sapphire may be used for the single crystal body. The purity (or content) of Al₂O₃ of the sapphire may be 99% by mass or more for high scratch resistance and breakage resistance.

The back plate 2 and the frame body 3 as well as the frame body 3 and the light-transmissive cover plate 1 may be bonded together through a metal layer. One method that can be used to accomplishing this bonding is the so-called metallized bonding method. For example, in bonding the light-transmissive cover plate 1 to the frame body 3, metallized layers are formed on the respective surfaces of the bonded portions of the light-transmissive cover plate 1 and the frame body 3. Then metal plating layers are formed on the surfaces of the formed metallized layers. Subsequently a brazing material is applied so as to be interposed between respective plating layers by making the bonded portions of the light-transmissive cover plate 1 and the frame body 3 face each other. Then, the brazing material is melted by raising the temperature of the entire body and then fixed.

For example, metallized layers containing any one of Mo—Mn, W—Mn, Cu—Ti, and Ag—Cu—Ti as a main component are formed on the respective surfaces of the bonded portions of the light-transmissive cover plate 1 and the frame body 3. Then, the surfaces are coated with nickel (Ni) plating layers. More specifically, a metal paste can be obtained by mixing Mo (molybdenum) powder, Mn (manganese) powder, and silicon dioxide (SiO₂) powder with an organic binder and a solvent. The metal paste may be applied to the respective surfaces of the bonded portions of the light-transmissive cover plate 1 and the frame body 3 by printing and coating so as to have a thickness of 10 μm. Then, a metallized layer is formed by firing at a temperature of 1400° C. in forming gas that is dried and humidified. Then the surface of the metallized layer is coated with the Ni plating layer with a thickness of approximately 2 μm using an electroplating method. Next, solder is applied so as to be interposed between the respective plating layers. The solder may contain any one of SnAgCu, SnZnBi, SnCu, SnAgInBi, SnZnAl, SnPb, and the like as a main component and may be melted at a relatively low temperature. The solder can be melted when the temperature of the entire body is increases and reaches to a predefined temperature. The solder is then solidified when the entire body is cooled down to a predefined temperature. As a result, the light-transmissive cover plate 1 is bonded to the frame body 3. The back plate 2 can be bonded to the frame body 3 in the same manner.

Alternatively, the light-transmissive cover plate 1 and the frame body 3, and/or the frame body 3 and the back plate 2 may be bonded to each other by direct bonding; that is, by bringing the members into direct contact with each other without providing a bonding layer that contains a metal or the like as a main component. The direct bonding may include a first method of bonding by activating a surface of a bonding portion, and a second method of bonding by heat.

In the first method of bonding by activating a surface, a surface of the body to be bonded is etched by being radiated by ion beams or neutron beams in a vacuum to be etched or is chemically etched in a chemical solution. In this bonding, respective members can be bonded by solid phase bonding (or solid state bonding) that uses an atomic force.

In the second method of bonding by heat, after respective surfaces of bonding portions are polished to have a center line average roughness of 500 Å or less, the respective polished bonding surfaces are positioned to face each other and then are brought into contact with each other at room temperature. Then, the surfaces are heated at an elevated temperature in vacuum in order for bonding to occur. The temperature may be 1000° C. or higher, and a pressure in vacuum may be 1.3×10⁻³ Pa or less.

In this direct bonding, the surfaces of respective members are bonded to each other with physicochemical bonding force. The method of bonding and the form of the bonding portion of the exterior body 4 are not particularly limited. The electronic apparatus with the sapphire body produced by metalizing or direct bonding can be airtightness than sapphire body attached to each other with a double-sided tape or an adhesive. As a result, the electronic apparatus 100 can have, for example, excellent waterproof performance.

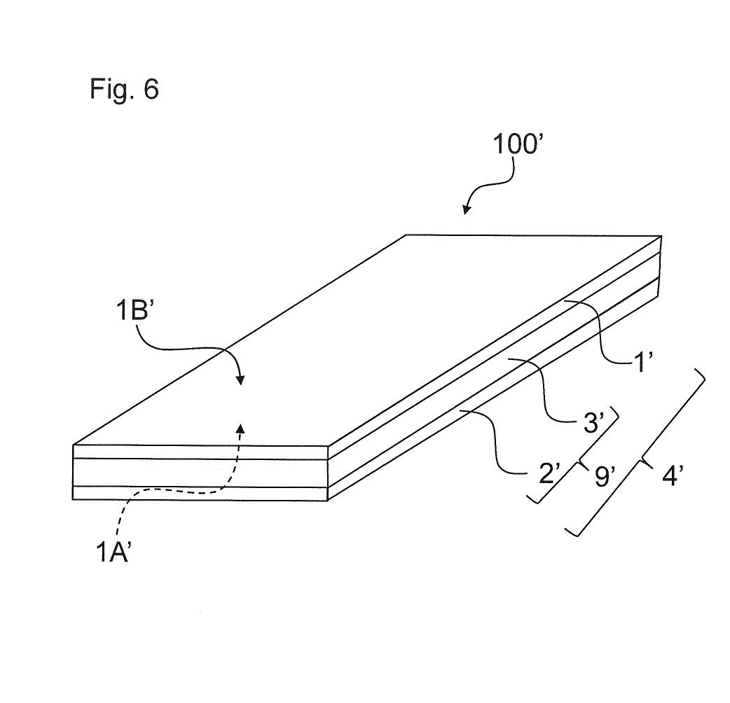

FIG. 6 is a perspective view of an exemplary electronic apparatus 100 according to an embodiment. In this embodiment, only the configuration of a case member 9′ is different from that illustrated in FIG. 1. The case member 9′ includes a plurality of members including a first member and a second member while the case member 9 includes only sapphire components. The first member includes a single crystal that contains alumina (Al₂O₃) as a main component while the second member contains a metal as a main component. The first member and the second member are bonded to each other. As illustrated in FIG. 6, the first member includes a back plate 2′ on an opposite side to a light-transmissive cover plate 1′ with respect to an image display device 52.

More specifically, the electronic apparatus 100′ includes a light-transmissive cover plate 1′, a back plate 2′ and a frame body 3′. The transmissive cover plate 1′ includes a first surface 1A′ that faces an image display surface of the image display device 52 and a second surface 1B′ that is positioned on the opposite side of the first surface 1A′. The back plate 2′ corresponds to the first member and the frame body 3′ corresponds to the second member. The light-transmissive cover plate 1′ and the back plate 2′ may include a single crystal containing alumina (Al₂O₃) as a main component. The frame body 3′ may contain aluminum (Al) as a main component. The light-transmissive cover plate 1′ and the back plate 2′ may have a substantially rectangular shape in a plan view. The light-transmissive cover plate 1′, the back plate 2′, and the frame body 3′ are combined to form an exterior body 4′.

The light-transmissive cover plate 1′ and the back plate 2′ may essentially consist of sapphire and the frame body 3′ may contain a metal as a main component. The frame body 3′ and the back plate 2′ may be bonded to each other through metal layers that are formed by, for example, a so-called metallized bonding method. The bonding method used herein can be the same method as described in the paragraphs above.

In the electronic apparatus 100 as illustrated in FIG. 4, the back plate 2 includes a microphone hole 21 on a rear surface thereof. A microphone 57 converts a voice from the outside of the electronic apparatus 100 into an electrical signal, and is located in the microphone hole 21. Further, as illustrated in FIG. 4, the electronic apparatus 100 includes an imaging lens 58a therein. The imaging lens 58a can be seen through the back plate 2. Since the back plate 2 is composed of sapphire which has high transparency, the outside image can be captured by the imaging unit 58 disposed inside the exterior body 4 without exposing the imaging lens 58a to the outside. The imaging unit 58 may be a camera device, may include the imaging lens 58a and an imaging element, and may image a still image and a moving image based on the instructions of a control unit 500.

Further, an electrode terminal 59a is disposed on the back plate 2 and exposed to the outside. The electrode terminal 59a penetrates the back plate 2 from the outside to the inside, is connected to a battery 59 disposed in the exterior body 4, and can supply (or charge) a current to the battery 59 from the outside of the electronic apparatus 100. The battery 59 may be a rechargeable battery such as a lithium ion battery and can be charged by the current flowing in through the electrode terminal 59a. Further, the current is supplied to respective members housed in the exterior body 4 through wirings or the like. The battery 59 supplies electrical energy output to respective electronic components included in the control unit 500 or the wireless communication unit 510, which are included in the electronic apparatus 100.

The wireless communication unit 510 transmits and receives wireless signals, which is composed of electromagnetic waves having a wavelength band of an Ultra High Frequency (UHF) with a wavelength of 10 cm to 1 m and a wavelength band of infrared light with a wavelength of 0.7 μm to 2.4 μm.

Sapphire has a small dielectric loss with respect to a high frequency wireless signal, thereby having good transmission characteristics for the electromagnetic waves when compared to glass or a resin. In an embodiment, the electromagnetic waves can be transmitted and received with small loss in signal strength over a wide range of wavelength by transmitting or receiving a wireless signal to/from the outside through sapphire of at least a portion of the case member 9.

In one embodiment, all components of the exterior body 4 such as the light-transmissive cover plate 1, the back plate 2 and the frame body 3 may consist of sapphire. Alternatively, in an alternative embodiment, all components of the exterior body 4 may not include sapphire. For example, only at least a part of the frame body 3 and the back plate 2 of the case member 9 may include sapphire and the electromagnetic waves may be received or transmitted through a portion of sapphire. In addition, an antenna wiring may be formed in the back plate 2 and be exposed to the outer surface of the back plate 2 and the wireless communication unit 50 may transmit or receive a wireless signal through the antenna wiring.

In the above-described embodiments, all of the back plate 2 or the back plate 2′ are composed of sapphire, but the case member may partially include a single crystal body that contains alumina (Al₂O₃) as a main component. For example, a part of the back plate 2 or a part of the frame body 3 may be composed of sapphire.

As illustrated in FIG. 2 the control unit 500 includes a CPU 500a and a storage unit 500b, and manages overall operations of the electronic apparatus 100 by controlling other configuration elements of the electronic apparatus 100. The storage unit 500b may include a ROM and/or a RAM. Various functional blocks are formed in the control unit 500 by the CPU 500a executing various programs in the storage unit 500b. The control unit 500 receives a large amount of and a variety of information from the respective configuration elements and performs processing on the information in a relatively short period of time.

The wireless communication unit 510 receives a signal from a communication device such as a web server connected to the Internet or a mobile phone different from the electronic apparatus 100 using an antenna 510a. A wireless information processing unit 510b performs an amplification process and down conversion on the reception signal, outputs the signal to the control unit 500, performs up conversion and the amplification process on a transmission signal that is generated in the control unit 500, sends the signal to the antenna 510a, and transmits the signal to the outside through the antenna 510a. The transmission signal from the antenna 510a is received by a communication device that is connected to a mobile phone that is different from the electronic apparatus 100 or the Internet via a base station or the like. The control unit 500 performs demodulation processing or the like on the input reception signal and acquires a sound signal indicating a voice or music included in the reception signal.

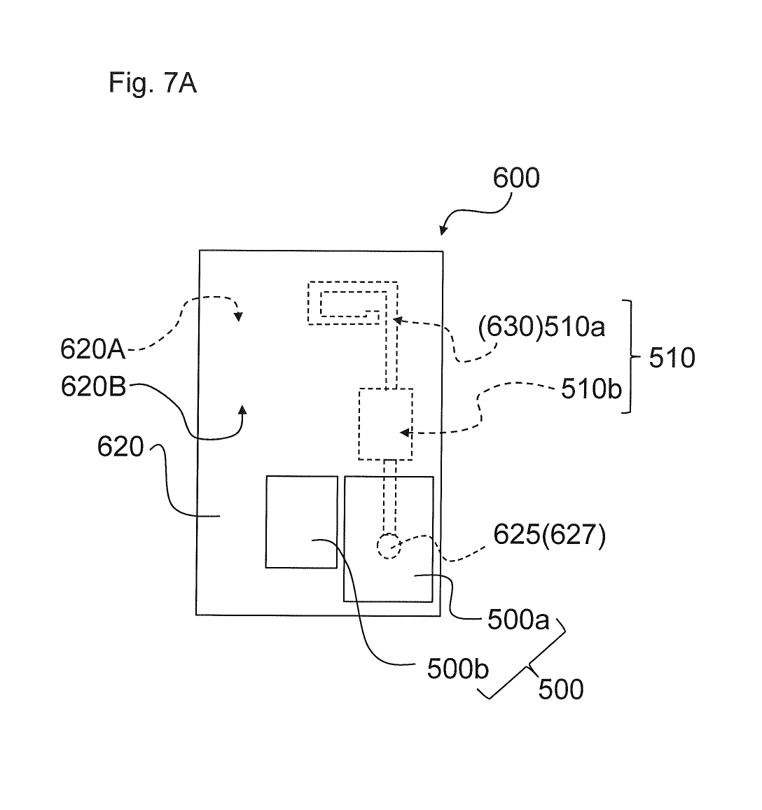

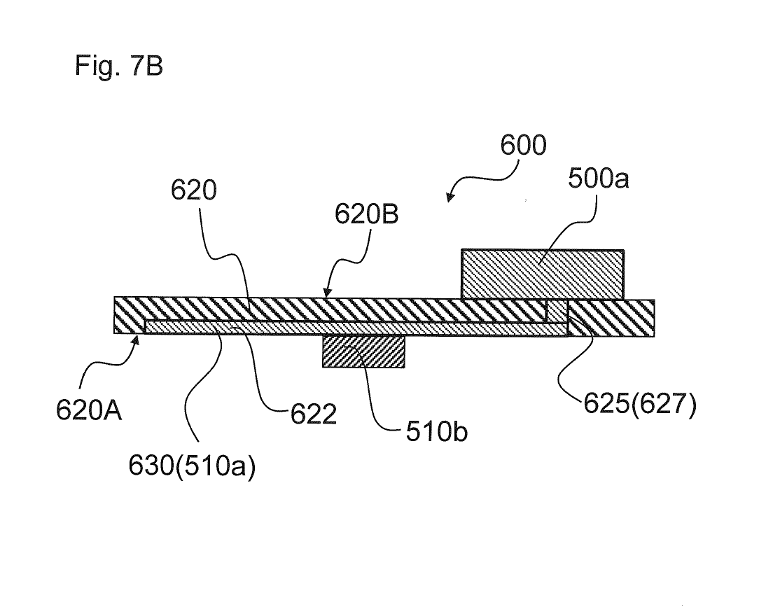

A mounting body 600 is disposed inside the exterior body 4, and includes a mount board 620 which is composed of sapphire. The mount board 620 includes the wireless communication unit 510 and the control unit 500 thereon. FIG. 7A is a plan view of mounting body 600, and FIG. 7B is a cross-sectional view of the mounting body 600 illustrated in FIG. 7A.

As illustrated by FIG. 7B, the mounting body 600 includes a first surface 620A, the mount board 620 and a metallic body 630. The mount board 620 includes a concave portion 622 on the first surface 620A thereof. The metallic body 630 is disposed inside the concave portion 622 and bonded to the inner surface of the concave portion 622. The metallic body 630 includes a surface that is approximately flush with the first surface 620A. In the present embodiment, the metallic body 630 may contain silver (Ag) as a main component. In addition, the metallic body 630 may further contain copper (Cu) and titanium (Ti). Further, the mount board 620 may include a through-hole 625 having an opening on the bottom surface of the concave portion 622 and on a second surface 620B. A via conductor 627 may be composed of a metal and may fill the through-hole 625.

In the mounting body 600, the wireless communication unit 510 and the control unit 500 are located on or in the mount board 620. The control unit 500 includes the CPU 500a and the storage unit 500b and the control unit 500 includes the CPU 500a and the storage unit 500b on the second surface 620B thereof. In addition, the wireless communication unit 510 is disposed on the first surface 620A side and includes an antenna 510a and the wireless information processing unit 510b. The antenna 510a includes a metallic body 630. The wireless information processing unit 510b is mounted on the mount board 620. The wireless information processing unit 510b, the CPU 500a, and the storage unit 500b are device components including semiconductor elements. In the mounting body 600, the metallic body 630 acts not only as a part of the antenna 510a but also as an electrical wiring. For example, the CPU 500a is electrically coupled to the storage unit 500b, and the wireless information processing unit 510b via the metallic body 630 as a part of the electrical wiring along with the via conductor 627.

The mount board 620 can have high thermal conductivity because the mount board 620 is composed of sapphire. As a result, the heat emitted from the wireless communication unit 510 and/or the control unit 500 can be efficiently dissipated from the mounting body 600. Since sapphire has low electrical resistance, a dark current flowing the surface of the mount board 620 may be small. Therefore, the CPU 500a, the storage unit 500b, or the wireless information processing unit 510b, which are all mounted on the surface of the mount board 620, may be less likely to malfunction because of a dark current.

As shown by FIG. 7A, the wireless information processing unit 510b, the CPU 500a, and the storage unit 500b are mounted on the mount board 620. However, such device components including semiconductor elements may be integrally formed on the mount board 620 by performing processing on a compound semiconductor layer that is formed on the mount board 620.

Moreover, the wireless communication unit 510 and/or the control unit 500 may generate relatively large amounts of heat during transmission/reception of a wireless signal or information processing. When the heat generated by the wireless communication unit 510 and the control unit 500 remains in the exterior body 4, the temperature in the exterior body 4 is increased. Such temperature increase may cause slowdown or malfunction of the operation of the CPU 500a, as well as malfunction of other constituent elements of respective units in the exterior body 4.

The heat generated from the wireless communication unit 510 and/or the control unit 500 may be efficiently released to the outside of the exterior body 4 through the light-transmissive cover plate 1, the back plate 2, and/or the frame body 3. This is because the electronic apparatus 100 includes the mount board 620, the light-transmissive cover plate 1, the back plate 2, and the frame body 3 may be partially or totally composed of sapphire. The thermal conductivity of the sapphire is approximately 42 W/(m·K), which is larger than that of quartz glass or the like whose thermal conductivity is 1 W/(m·K). The higher thermal conductivity of the sapphire members may lead to heat generated during operation to being more efficiently released to the outside.

In addition, the light-transmissive cover plate 1 that is composed of sapphire has high hardness, and therefore the light-transmissive cover plate 1 may have high scratch resistance and breakage resistance.

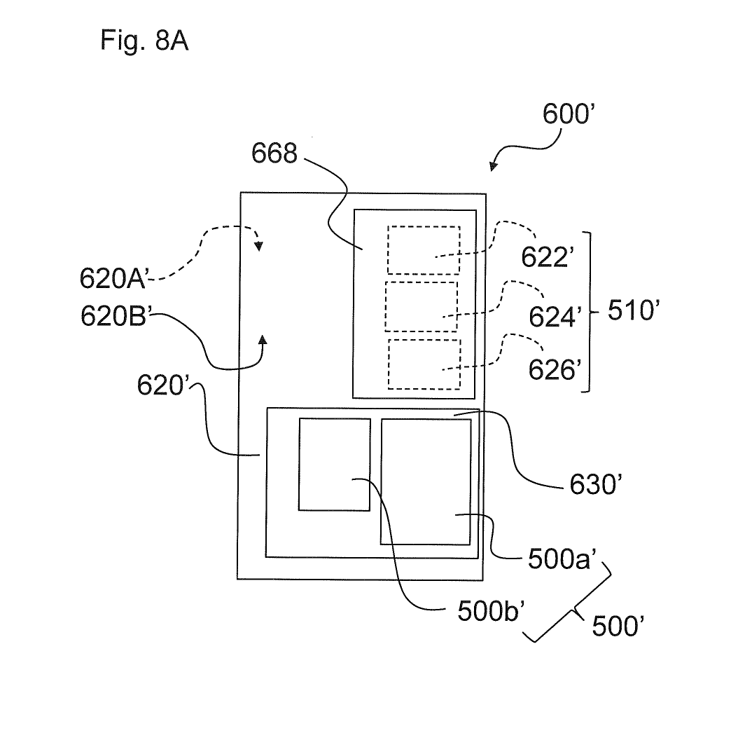

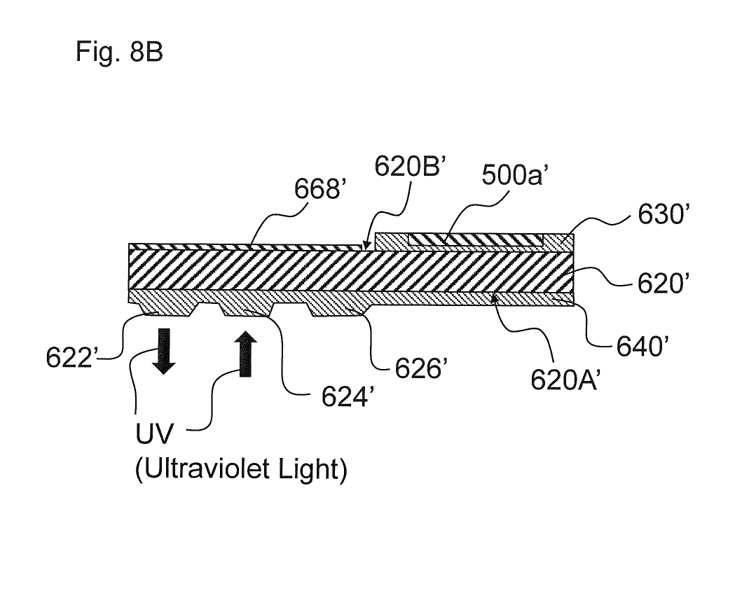

FIG. 8A is a plan view of an exemplary mounting body 600′, and FIG. 8B is a cross-sectional view of the mounting body illustrated in FIG. 8A. The electronic apparatus 100 can execute various kinds of software and perform photographing of an image or communication with the outside in response to an input to a touch panel, or can receive or transmit information even in water such as seawater as easily as in the air. The electronic apparatus 100 can also be used in a special environment such as a vacuum, an environment with dusty air, a high humidity environment or a harsh chemical environment.

A wireless communication unit 510′ may perform wireless communication with the outside of the exterior body 4 using visible light or ultraviolet light as a wireless signal. The visible light may have a wavelength of 400-700 nm and the ultraviolet light signal can have a wavelength of 400 nm or less. They are shorter than that of the wavelength band such as infrared light used for a conventional portable electronic apparatus. Sapphire has relatively high transmission characteristics with respect to light having a wavelength of 700 nm or less compared to glass or resins. Therefore, a light having a wavelength of 700 nm or less can pass through the sapphire and, the electronic apparatus 100 can perform reception or transmission of ultraviolet light signal as a signal with a small loss over a wide range of wavelength. In the present embodiment, reception or transmission of the light can be performed with the outside of the exterior body 4 by allowing the light to pass through mainly the back plate 2 among members constituting the exterior body 4. The light-transmissive cover plate 1, the back plate 2, and the frame body 3 constituting the exterior body 4 are made of sapphire. In the back plate 2, only a portion thereof may be made of sapphire but not the entire back plate. In this case, the light can be received or transmitted through the portion. Hereinafter the light having the wavelength of 700 nm or less may be called the information light.

Bonding or direct bonding using a metal layer can improve airtightness of the electronic apparatus when compared to the case in which members made of sapphire are attached to each other using a double-sided tape or an adhesive, therefore high waterproofing performance can be realized. Therefore, the electronic apparatus 100 has high waterproofing performance so that a user can dive into water with the electronic apparatus 100. Further, since sapphire is difficult to be broken because of its excellent mechanical strength, it is difficult to be broken when used in an environment in which high water pressure is applied, such as in relatively deep water. The electronic apparatus 100 can perform communication even in deep water with another electronic apparatus that is positioned at a relatively distant position.

A control unit 500′ includes a CPU 500a′ and a storage unit 500b′ and manages overall operations of the electronic apparatus 100 by controlling other configuration elements of the electronic apparatus 100. The storage unit 500b′ is configured of a ROM and a RAM. Various functional blocks are formed in the control unit 500′ by the CPU 500a′ executing various programs in the storage unit 500b′. The control unit 500′ receives a large amount of diverse information from the respective constituent elements and performs processing (information processing) on the information in a relatively short time.

The wireless communication unit 510′ includes a light receiving unit 624′ that receives the information light as a signal containing information from a communication device such as a web server which is connected to the Internet or from an electronic apparatus different from the electronic apparatus 100. A wireless information processing unit 510b′ performs an amplification process and down conversion on the signal of the received information light, outputs the signal to the control unit 500′, performs up conversion and the amplification process on a transmission signal that is generated in the control unit 500′, sends the signal to a light emitting unit 622′, and transmits the signal to the outside as a signal of information light through the light emitting unit 622′. The transmission signal from the light emitting unit 622′ is received by a communication device that is connected to the Internet or an electronic apparatus that is different from the electronic apparatus 100′. The control unit 500′ performs demodulation processing or the like on the input reception signal and acquires information indicating a voice, music, or an image included in the reception signal.

A semiconductor device 600′ is disposed in the exterior body 4. The semiconductor device 600′ may include a wireless communication unit 510′, a control unit 500′ and a mount board 620′ that is composed of sapphire. The wireless communication unit 510′ and the control unit 500′ are located on the mount board 620′. The control unit 500′ may include a CPU 500a′, a storage unit 500b′ and the mount board 620′. The CPU 500a′ and the storage unit 500b′ are located on a second surface 620B′ of the mount board 620′. In addition, the wireless communication unit 510′ may include the light emitting unit 622′, the light receiving unit 624′, and the wireless information processing unit 626′ on the first surface 620A′ side thereof. Further, the second surface 620B′ may include a reflection film 668′ that reflects light from the light emitting unit 622′ thereon. The reflection film 668′ is a thin film that is made of silver (Ag), and reflects light emitted from the light emitting unit 622′ downward in the drawing. The light emitting unit 622′, the light receiving unit 624′, the CPU 500a′, the storage unit 500b′, and/or the wireless information processing unit 626′ are electrically connected to one another through a via-hole wiring or the like.

A compound semiconductor layer 640′ may include all of the light emitting unit 622′, the light receiving unit 624′ and the wireless information processing unit 626′ and may be disposed on a first surface 620A′ of the mount board 620′. Further, a semiconductor substrate 630′ may be located on a second surface 620B′ of the mount board 620′, and may include the CPU 500a′ and the storage unit 500b′ therein.

The light emitting unit 622′ may have a so-called LED element structure that includes the compound semiconductor layer 640′ on the mount board (or base member) 620′ and emits information light according to the input current (or an electrical signal). In addition, the light receiving unit 624′ has a so-called photodiode element structure that is configured by including the compound semiconductor layer 640′ formed in the mount board 620′ and generates the current or electrical signal according to the received information light.

The compound semiconductor layer 640′ may include a group III-V compound semiconductor as a main component. More specifically, the compound semiconductor layer 640′ is formed on the first surface 620A′ of the mount board 620′ by an epitaxial growth method. The compound semiconductor layer 640′ includes compound semiconductor such as group III-V compound semiconductor, and more specifically, a nitride-based semiconductor. The nitride-based semiconductor includes an AGIN semiconductor represented by AlₓGa_{1-x-y}In_{y}N, where x, y and the total of x and y are equal to or greater than 0; and x, y, and the total of x and y is equal to or less than 1 (0≦x, y, x+y≦1). The AGIN semiconductor has a lattice constant close to that of a sapphire single crystal, thereby allowing the compound semiconductor layer 640′ epitaxially grow on the first surface 620A′ and have fewer crystal defects and high crystallinity.

The light emitting unit 622′ and the light receiving unit 624′ are formed on the compound semiconductor layer 640′ which has epitaxially grown and has high crystallinity. That is, the light emitting unit 622′ and the light receiving unit 624′ are formed by performing processing on the compound semiconductor layer 640′ after a known process of producing a semiconductor element. In addition, the wireless information processing unit 626′ has an electronic device element structure that is formed on the compound semiconductor layer 640′. The electronic device element structure has a so-called CMOS element function or the like and can allow performing processing on an electrical signal. The electronic device element structure is formed by a known process for producing a semiconductor element.

The wireless information processing unit 626′ transmits an electrical signal to the light emitting unit 622′ through an electrical wiring that is formed on the compound semiconductor layer 640′. The light emitting unit 622′ emits information light corresponding to the transmitted electrical signal. Further, the light receiving unit 624′ receives the information light that arrives by passing through the exterior body 4 from the outside and transmits an electrical signal corresponding to the received information light to the wireless information processing unit 626′.

The group III-V compound semiconductor, more particularly the AGIN semiconductor has a wide-bandgap and a direct transition type band structure. When including the group III-V compound semiconductor, an electronic device element can have high processing performance on a high-frequency signal and can transmit an electrical signal with a high output. When including the group III-V compound semiconductor, a light-emitting element (or LED element) can have high responsiveness with respect to the input electrical signal and can emit light with high intensity corresponding to the input electrical signal. Moreover, various characteristics such as the size of the band gap or the light emitting wavelength can be finely adjusted in a wide range by adjusting the content ratios of various elements such as aluminum (Al), gallium (Ga), indium (In), and nitrogen (N).

The semiconductor substrate 630′ is, in one variation, a silicon single crystal substrate having a thickness of 0.01 mm to 0.5 mm. The silicon single crystal substrate is bonded to the second surface 620B′ of the mount board 620′ by an above-described bonding technology. For example, the second surface 620B′ of the mount board 620′ and a surface of the semiconductor substrate 630′ are etched by radiating ion beams in a vacuum or by immersing the surface using a chemical solution. Alternatively, the mount board 620′ is directly bonded to the semiconductor substrate 630′.

The wireless information processing unit 626′ and the CPU 500a′ includes the above-described high electrical signal processing performance, the wireless information processing unit 626′ generates an electrical signal with high precision corresponding to information light received by the light receiving unit 624′ and sends the electrical signal to the CPU 500a′, and the CPU 500a′ can perform signal processing on the electrical signal at high speed with high precision.

In the semiconductor device 600′, since the wireless information processing unit 626′ that is formed on the compound semiconductor layer 640′ and has high signal processing performance and the CPU 500a′ that is formed in the semiconductor substrate 630′ and has high signal processing performance are disposed on both surfaces (the first surface 620A′ and the second surface 620B′) of the mount board 620′ in a stacked manner, the size thereof is relatively small and the semiconductor device has high information processing precision.

Moreover, the light emitting unit 622′, the light receiving unit 624′, the wireless information processing unit 626′, the CPU 500a′, or the storage unit 500b′ may be formed on the surface of the back plate 2 or the light-transmissive cover plate 1 containing sapphire as a main component, and details of the respective functional units are not particularly limited.

For example, in a case where the user dives into water by carrying the electronic apparatus 100 having the configuration of the embodiment illustrated in FIGS. 8A and 8B, the user can transmit information related the current state of himself or herself in real time to a person who has dived into water while carrying the same apparatus at the same time by generating text information, for example, with a touch panel operation and transmitting the information in a wireless manner (information light). Further, the user can transmit an image or moving information onto land or a ship in real time while diving. Further, the user can confirm an instruction from land or a ship with a voice while being present in water. Furthermore, this can be applied to an electronic apparatus used for other devices than a portable device. For example, the apparatus can be applied to a communication device performing wireless communication between users in seawater by being installed to a device such as a manned submarine or an unmanned seabed probe.

As illustrated in FIG. 2, the light-transmissive cover plate 1 includes a first surface 1A facing an image display surface of the image display device 52, and a second surface 1B on the opposite side of the first surface 1A. The light-transmissive cover plate 1 may include a display portion 1a as illustrated in FIG. 3. The display portion 1a can display various pieces of information such as characters, symbols, and figures. The display portion 1a may have a rectangular shape in a plan view. A peripheral edge 1b is a non-display portion on which the information is not displayed and surrounds the display portion 1a in the light-transmissive cover plate 1 may be black color. The peripheral edge 1b may have a film or the like attached thereto. A touch panel 53 is attached to an inner surface of the light-transmissive cover plate 1 and the user can give various instructions with respect to the electronic apparatus 100 by operating the display portion 1a of the second surface 1B of the light-transmissive cover plate 1 with a finger or the like.

The electronic apparatus 100 can include the image display device 52 as described above. The image display device 52 displays various information with characters, symbols, and figures on the image display surface by being controlled by the control unit 500.

The image display device 52 is, for example, a liquid crystal image display device as described above and displays various pieces of information such as characters, signals, and drawings on the image display surface under the control of the control unit 500. The light indicting image information displayed on the image display device 52 passes through the light-transmissive cover plate 1 and enters eyes of a user of the electronic apparatus 100, and accordingly the information can be recognized by the user of the electronic apparatus 100.

The touch panel 53 may be a projection type electrostatic capacitance touch panel and detects an operation of the user on the second surface 1B of the light-transmissive cover plate 1. The touch panel 53 is attached to the first surface 1A side of the light-transmissive cover plate 1 and includes two sheets each having a sensing electrode pattern which are arranged so as to face each other. Two sheets of sensing electrode pattern are bonded to each other using a transparent adhesive sheet.

A plurality of long and narrow X electrodes that extend along an X-axis direction (for example, a lateral direction of the electronic apparatus 100) and are arranged in parallel with each other are formed on one sensing electrode pattern sheet. A plurality of long and narrow Y electrodes which respectively extend along a Y-axis direction (for example, a vertical direction of the electronic apparatus 100) and are arranged in parallel with each other are formed in the other sensing electrode pattern sheet. When a finger of the user is touched on the second surface 1B of the light-transmissive cover plate 1, the electrostatic capacitance between an X electrode and a Y electrode positioned below the touched portion is changed so that the touch panel 53 detects the operation on the second surface 1B of the light-transmissive cover plate 1. The change in the electrostatic capacitance between the X electrode and the Y electrode, which is generated in the touch panel 53, is transmitted to the control unit 500. The control unit 500 specifies the content of the operation performed on the second surface 1B of the light-transmissive cover plate 1 based on the change in the electrostatic capacitance and performs an operation according to the specified contents.

The piezoelectric vibrating element 55 is an element for transmitting a reception sound to the user of the electronic apparatus 100. The piezoelectric vibrating element 55 is vibrated by a driving voltage applied by the control unit 500. The control unit 500 generates a driving voltage based on a sound signal indicating the reception sound and applies the driving voltage to the piezoelectric vibrating element 55. The piezoelectric vibrating element 55 is vibrated by the control unit 500 based on the sound signal indicating the reception sound and thus the reception sound is transmitted to the user of the electronic apparatus 100. In this manner, the control unit 500 functions as a driving unit allowing the piezoelectric vibrating element 55 to vibrate based on the sound signal. The piezoelectric vibrating element 55 will be described below in detail.

The microphone 57 outputs the sound input by the outside of the electronic apparatus 100 to the control unit 500 by converting a sound into the electric sound signal a sound. The sound from the outside of the electronic apparatus 100 is incorporated in the electronic apparatus 100 from microphone holes 21 provided on the back plate 2 of the electronic apparatus 100 and is input to the microphone 57.

The imaging unit 58 has the imaging lens 58a, an imaging element, and the like, and images a still image and a moving image based on the control of the control unit 500.

The battery 59 outputs a power source of the electronic apparatus 100. The power source output from the battery 59 is supplied to respective electronic components such as the control unit 500 or the wireless communication unit 51 in the electronic apparatus 100.

<Details of Piezoelectric Vibrating Element>

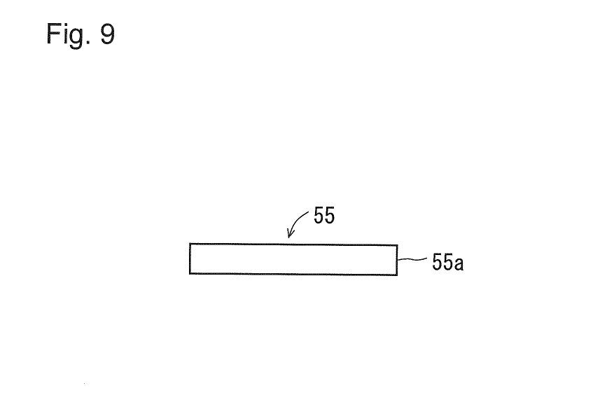

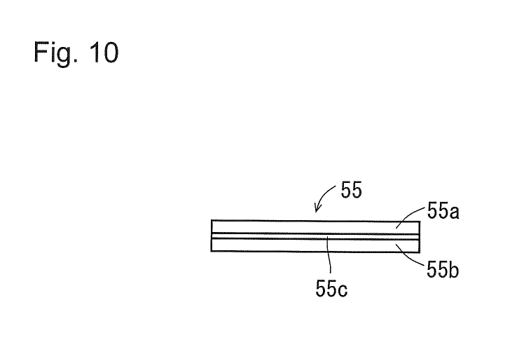

FIGS. 9 and 10 are respectively a top view and a side view illustrating a structure of the piezoelectric vibrating element 55. As illustrated in FIGS. 9 and 10, the piezoelectric vibrating element 55 has a long shape in one direction. Specifically, the piezoelectric vibrating element 55 has a long and narrow rectangular plate shape in a plan view. The piezoelectric vibrating element 55 has, for example, a bimorph structure and includes a first piezoelectric ceramic plate 55a and a second piezoelectric ceramic plate 55b which are attached to each other through a shim material 55c.

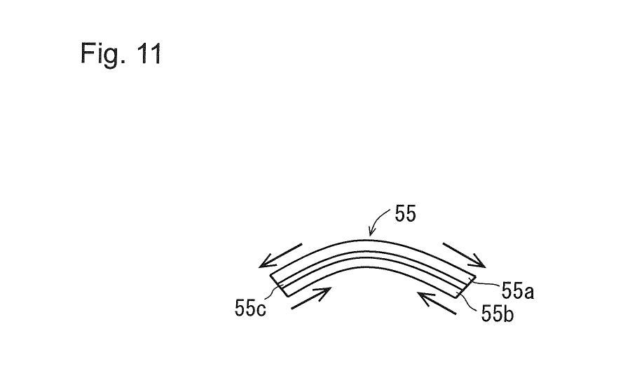

In the piezoelectric vibrating element 55, when a positive voltage is applied to the first piezoelectric ceramic plate 55a and a negative voltage is applied to the second piezoelectric ceramic plate 55b, the first piezoelectric ceramic plate 55a extends along the longitudinal direction and the second piezoelectric ceramic plate 55b contracts along the longitudinal direction. Accordingly, as illustrated in FIG. 11, the piezoelectric vibrating element 55 is bent into a convex shape with the first piezoelectric ceramic plate 55a being outside.

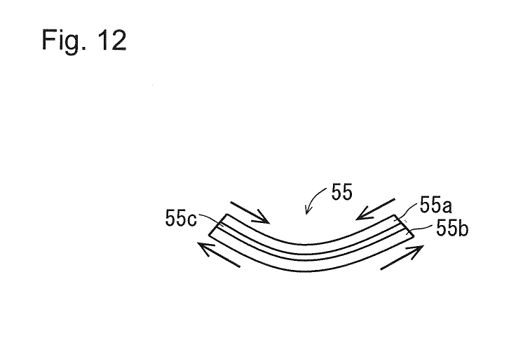

In contrast, in the piezoelectric vibrating element 55, when a negative voltage is applied to the first piezoelectric ceramic plate 55a and a positive voltage is applied to the second piezoelectric ceramic plate 55b, the first piezoelectric ceramic plate 55a contracts along the longitudinal direction and the second piezoelectric ceramic plate 55b extends along the longitudinal direction. Accordingly, as illustrated in FIG. 12, the piezoelectric vibrating element 55 is bent into a convex shape with the second piezoelectric ceramic plate 55b being outside.

The piezoelectric vibrating element 55 vibrates while being bent by alternatively taking the state of FIG. 11 and the state of FIG. 12. The control unit 500 allows the piezoelectric vibrating element 55 to vibrate while being bent by applying an AC voltage in which the positive voltage and the negative voltage alternatively appear at an area between the first piezoelectric ceramic plate 55a and the second piezoelectric ceramic plate 55b.

FIGS. 10 to 12 illustrates one structure made of the first piezoelectric ceramic plate 55a and the second piezoelectric ceramic plate 55b which are bonded to each other by interposing the shim material 55c therebetween in the piezoelectric vibrating element 55. However, a plurality of the structures may be laminated to each other.

<Arrangement Position of Piezoelectric Vibrating Element>

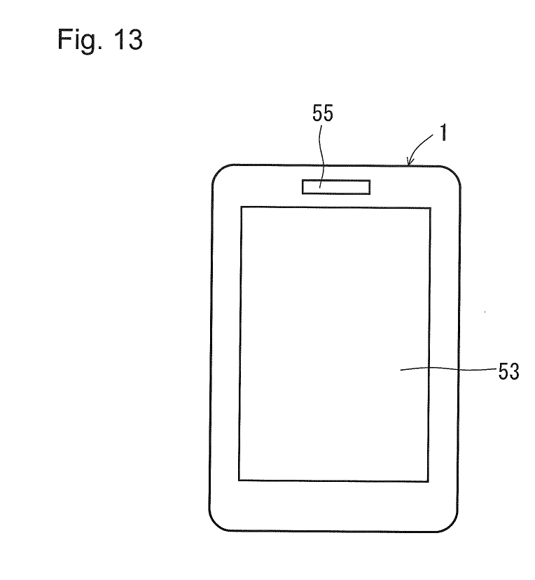

FIG. 13 is a plan view when the light-transmissive cover plate 1 is seen from the first surface 1A side. The piezoelectric vibrating element 55 is attached to the first surface 1A of the light-transmissive cover plate 1 using an adhesive such as a double-sided tape. The piezoelectric vibrating element 55 is arranged in a position which is not overlapped with the image display device 52 and the touch panel 53 when the piezoelectric vibrating element 55 is seen from side of the first surface 1A of the light-transmissive cover plate 1 in a plan view.

<Regarding Generation of Reception Sound Due to Vibration of Piezoelectric Vibrating Element>

In the present embodiment, an air conduction sound and a conduction sound are transmitted to the user from the light-transmissive cover plate 1 via the vibration of the piezoelectric vibrating element 55. That is, the vibration of the piezoelectric vibrating element 55 is transmitted to the light-transmissive cover plate 1 so that the air conduction sound and the conduction sound are transmitted to the user from the light-transmissive cover plate 1.

Here, the term “air conduction sound” means a sound recognized in a human brain by the vibration of an eardrum due to a sound wave or air vibration which enters an external auditory meatus hole (also known as an “ear hole”). On the other hand, the term “conduction sound” is a sound recognized in a human brain by the vibration of the eardrum due to the vibration of an auricle transmitted to the eardrum. Hereinafter, the air conduction sound and the conduction sound will be described in detail.

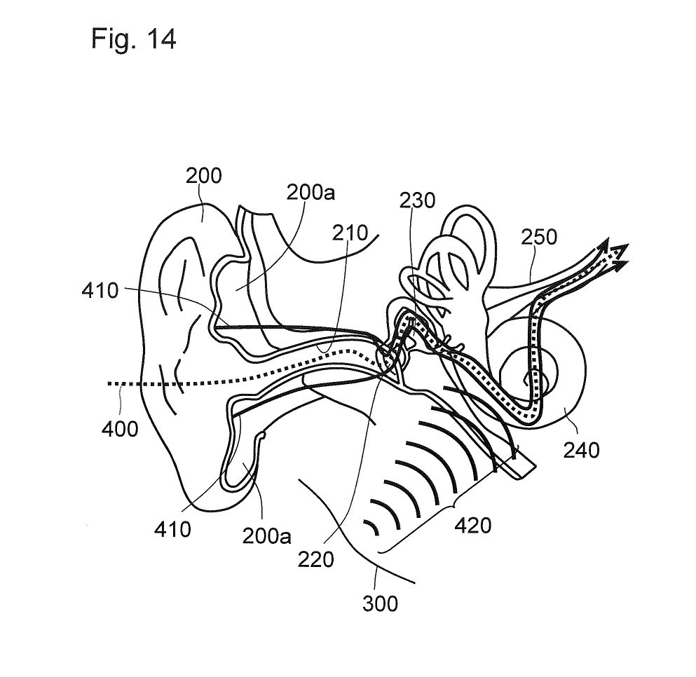

FIG. 14 is a view for describing the air conduction sound and the conduction sound. FIG. 14 illustrates a structure of an ear of the user of the electronic apparatus 100. In FIG. 14, a wavy line 400 indicates a conduction path of a sound signal of the air conduction sound. A solid line 410 indicates the conduction path of the sound signal of the conduction sound.

When the piezoelectric vibrating element 55 mounted to the light-transmissive cover plate 1 vibrates based on the electric sound signal indicating the reception sound, the light-transmissive cover plate 1 vibrates and a sound wave is outputted from the light-transmissive cover plate 1. When the user moves the light-transmissive cover plate 1 of the electronic apparatus 100 close to an auricle 200 of the user by holding the electronic apparatus 100 in a hand or the light-transmissive cover plate 1 of the electronic apparatus 100 is put to the auricle 200 of the user, the sound wave output from the light-transmissive cover plate 1 enters an external auditory meatus hole 210. The sound wave from the light-transmissive cover plate 1 enters in the external auditory meatus hole 210 and the eardrum 220 vibrates. The vibration of the eardrum 220 is transmitted to an auditory ossicle 230 and the auditory ossicle 230 vibrates. In addition, the vibration of the auditory ossicle 230 is transmitted to a cochlea 240 and is converted into an electrical signal in the cochlea 240. The electrical signal is transmitted to the brain by passing through an acoustic nerve 250 and the reception sound is recognized in the brain. In this manner, the air conduction sound is transmitted from the light-transmissive cover plate 1 to the user.

When the user puts the light-transmissive cover plate 1 of the electronic apparatus 100 to the auricle 200 of the user by holding the electronic apparatus 100 in a hand, the auricle 200 is vibrated by the light-transmissive cover plate 1 which is vibrated by the piezoelectric vibrating element 55. The vibration of the auricle 200 is transmitted to the eardrum 220, and thus the eardrum 220 vibrates. The vibration of the eardrum 220 is transmitted to the auditory ossicle 230, and thus the auditory ossicle 230 vibrates. The vibration of the auditory ossicle 230 is transmitted to the cochlea 240 and is converted into an electrical signal in the cochlea 240. The electrical signal is transmitted to the brain by passing through the acoustic nerve 250 and the reception sound is recognized in the brain. In this manner, the conduction sound is transmitted from the light-transmissive cover plate 1 to the user. FIG. 14 illustrates an auricular cartilage 200a in the inside of the auricle 200.

In addition, the conduction sound herein is different from a bone conduction sound. The bone conduction sound is a sound recognized in a human brain by the vibration of the skull and direct stimulation of the inner ear such as the cochlea caused by the vibration of the skull. In FIG. 14, in a case of vibrating the jawbone 300, the transmission path of the sound signal while the bone conduction sound is recognized in the brain is indicated with a plurality of arcs 420.

In this manner, in the electronic apparatus 100 according to the present embodiment, the air conduction sound and the conduction sound can be transmitted from the light-transmissive cover plate 1 to the user of the electronic apparatus 100 due to the vibration of the light-transmissive cover plate 1 through the vibration of the piezoelectric vibrating element 55. Since the user can hear a sound when the user puts the light-transmissive cover plate 1 to the auricle 200 of the user, the communication using a telephone can be performed without concerning the position of the electronic apparatus 100 put against an ear so much. In addition, the user can hear the conduction sound due to the vibration of the auricle, the electronic apparatus 100 makes it easy for the user to hear the sound even when there is a large amount of the ambient noise. Accordingly, the user can appropriately perform communication using a telephone even when there is a large amount of the ambient noise.

In addition, even in a state in which earplugs or earphones are fixed to the ears of the user, the reception sound from the electronic apparatus 100 can be recognized by putting the light-transmissive cover plate 1 to the auricle. Further, even in the state in which headphones are fixed to the ears of the user, the reception sound from the electronic apparatus 100 can be recognized by putting the light-transmissive cover plate 1 to the headphones.

<Regarding Holes of Ear Piece (Holes for Receiver)>

In the electronic apparatus 100 according to the present embodiment, since the reception sound is generated by the vibration of the light-transmissive cover plate 1, the reception sound can be appropriately transmitted to the user even through there are no holes in the ear piece of the light transmissive cover plate 1. Therefore, the production cost of the light transmissive cover plate 1 can be reduced because the laser processing cost needed to make such holes can be eliminated. Further, since the light-transmissive cover plate 1 has no holes in the ear piece, the strength of the light-transmissive cover plate 1 may be higher. Furthermore, in the present embodiment, since there are no holes of the ear piece on the surface of the electronic apparatus 100, problems of water or dust entering the holes of the ear piece are reduced. Therefore, the necessity or the cost for a water-proof or dust-proof structure for solving the above-described problem is reduced.

In the above-described embodiment, a mobile phone case to which the present invention is applied is described as an embodiment. However, the present invention can be applied to an electronic apparatus other than the mobile phone. For example, embodiments may be applicable to tablets, e-readers, digital cameras, game consoles, digital music players, personal digital assistants (PDA), personal handy phone system (PHS), laptop computers, portable TV's, Global Positioning Systems (GPS's) or navigation systems, machining tools, pedometers, health equipment such as weight scales, display monitors, smartwatches, wearables, and the like. In addition, the present invention is not limited to the above-described embodiments, and various modifications and changes may be made in the range not departing from the scope of the present invention.

Although example embodiments of the disclosure have been described above with reference to the accompanying drawings, it is understood that the embodiment of the disclosure is not limited to the above-described embodiments. Various alterations and modifications to the above embodiments are contemplated to be within the scope of the embodiments of the disclosure. It should be understood that those alterations and modifications are included in the technical scope of the embodiments of the disclosure as defined by the appended claims.

While at least one example embodiment has been presented in the foregoing detailed description, the present invention is not limited to the above-described embodiment or embodiments. Variations may be apparent to those skilled in the art. In carrying out the present invention, various modifications, combinations, sub-combinations and alterations may occur in regard to the elements of the above-described embodiment insofar as they are within the technical scope of the present disclosure or the equivalents thereof. The exemplary embodiment or exemplary embodiments are examples, and are not intended to limit the scope, applicability, or configuration of the invention in any way. Rather, the foregoing detailed description will provide those skilled in the art with a template for implementing the exemplary embodiment or exemplary embodiments. It should be understood that various changes can be made in the function and arrangement of elements without departing from the scope of the invention as set forth in the appended claims and the legal equivalents thereof. Furthermore, although embodiments of the present disclosure have been described with reference to the accompanying drawings, it is to be noted that changes and modifications may be apparent to those skilled in the art. Such changes and modifications are to be understood as being included within the scope of the present invention as defined by the claims.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. An electronic apparatus, comprising:
an exterior body;
a wireless communication unit in the exterior body; and
a display device in the exterior body, the display device including a display surface;
wherein the exterior body comprises:
a front side that includes a light-transmissive cover plate that comprises: a first surface facing the display surface and a second surface opposite to the first surface, the light-transmissive cover plate comprising a single crystal body containing alumina as a main component; and
a rear side on an opposite side of the exterior body relative to the front side, the rear side including a case member with an externally exposed back comprising a single crystal body containing alumina as a main component.

2. The electronic apparatus according to claim 1, wherein the case member includes at least two sapphire members that are connected to each other.

3. The electronic apparatus according to claim 2, wherein the at least two sapphire members comprises a bonding layer therebetween, the bonding layer containing a metal as a main component.

4. The electronic apparatus according to claim 2, wherein the two sapphire members are directly contacted with each other with no interlayer therebetween.

5. The electronic apparatus according to claim 1, wherein the case member further comprises a first member that is made of a single crystal body containing alumina (Al203) as a main component and a second member that contains a metal as a main component, the first member connected to the second member.

6. The electronic apparatus according to claim 5, wherein the first member comprises a back plate at an opposite side to the light transmissive cover plate with respect to the display device.

7. The electronic apparatus according to claim 5, wherein the first member and the second member comprises a bonding layer therebetween, the bonding layer containing a metal as a main component.

8. The electronic apparatus according to claim 5, wherein the first member is directly connected to the second member.

9. The electronic apparatus according to claim 1, wherein the wireless communication unit comprises a light emitting unit that emits ultraviolet light, and transmits information to the outside of the exterior body by sending the ultraviolet light to the outside of the exterior body through the single crystal body of the case member.

10. The electronic apparatus according to claim 1, wherein the wireless communication unit comprises a light receiving unit that receives ultraviolet light, and receives information from the outside of the exterior body by receiving the ultraviolet light through the single crystal body of the case member.

11. The electronic apparatus according to claim 1, further comprising:
a piezoelectric vibrating element arranged on the light transmissive cover plate that vibrates by a driving voltage based on a sound signal.

12. A electronic apparatus according to claim 11,
wherein the piezoelectric vibrating element vibrates for transmitting a conduction sound based on the sound signal.

13. The electronic apparatus according to claim 12,
wherein the piezoelectric vibrating element vibrates for transmitting an air conduction sound by the vibration based on the sound signal.

14. The electronic apparatus according to claim 13,
wherein the conduction sound and the air conduction sound are transmitted by the vibration of the light transmissive cover plate transmitted by the vibration of the piezoelectric vibrating element.

15. The electronic apparatus according to claim 11,
wherein the sound signal indicates a reception sound relating to telephone.

16. A portable device according to claim 14,
wherein the piezoelectric vibrating element has a long and narrow rectangular plate shape.

17. An electronic apparatus, comprising:
an exterior body;
a display device disposed in the exterior body, the display device including a display surface; and
the exterior body including a front side with a light transmissive cover plate disposed in the exterior body, the light transmissive cover plate facing the display surface;
wherein the exterior body comprises a rear side with an externally exposed back made of sapphire at an opposite side of the exterior body to the front side.

18. The electronic apparatus according to claim 17, further comprising a wireless communication unit disposed in the exterior body and facing the sapphire, the wireless communication emitting or receiving ultraviolet light.

19. (canceled)

20. The electronic apparatus according to claim 17, further comprising a imaging unit disposed in the exterior body and facing the sapphire.
